(19) United States
(12) Patent Application Publication
(10) Pub. No.: US 2025/0150995 A1
(43) Pub. Date: May 8, 2025

(54) INFORMATION DETERMINING METHOD AND APPARATUS, AND TERMINAL

(71) Applicant: VIVO MOBILE COMMUNICATION CO., LTD., Dongguan (CN)

(72) Inventors: Xin QU, Dongguan (CN); Kai WU, Dongguan (CN)

(73) Assignee: VIVO MOBILE COMMUNICATION CO., LTD., Dongguan (CN)

(21) Appl. No.: 19/019,131

(22) Filed: Jan. 13, 2025

Related U.S. Application Data
(63) Continuation of application No. PCT/CN2023/104937, filed on Jun. 30, 2023.

(30) Foreign Application Priority Data
Jul. 14, 2022 (CN) 202210834712.8

(51) Int. Cl. H04W 56/00

(52) U.S. Cl. CPC H04W 56/001

(57) ABSTRACT

An information determining method and a terminal are provided. The information determining method includes: obtaining time reference information of a first signal. The information determining method further includes determining Synchronization Signal Block (SSB) time information based on the time reference information.

### CROSS-REFERENCE TO RELATED APPLICATIONS

This application is a continuation of International Application No. PCT/CN2023/104937, filed on Jun. 30, 2023, which claims priority to Chinese Patent Application No. 202210834712.8, filed on Jul. 14, 2022. The entire contents of each of the above-referenced applications are expressly incorporated herein by reference.

### TECHNICAL FIELD

This application pertains to the field of communication technologies, and in particular, to an information determining method and apparatus, and a terminal.

### BACKGROUND

In New Radio (NR), a low-power wake-up module/receiver and a low-power wake-up signal are introduced. When a terminal is idle, a main communication module/receiver can be disabled or set to a deep sleep state, and only a low-power wake-up module is used to monitor a low-power wake-up signal, to reduce power consumption of the terminal. After the main communication module/receiver is awakened, a Synchronization Signal Block (SSB) is detected to obtain downlink time information for synchronization, Automatic Gain Control (AGC) adjustment, time-frequency tracking, Carrier Frequency Offset (CFO) compensation, and the like. However, because the main communication module/receiver cannot maintain accurate time information while disabled or in the deep sleep state, after being awakened, the main communication module/receiver can only blindly detect the SSB within a large time range, for example, an SSB periodicity, to determine a time domain position of the SSB. Consequently, power consumption is high.

### SUMMARY

Embodiments of this application provide an information determining method and apparatus, and a terminal.

According to a first aspect, an information determining method is provided. The method includes:

A terminal obtains time reference information of a first signal.

The terminal determines synchronization signal block SSB time information based on the time reference information.

According to a second aspect, an information determining apparatus is provided. The apparatus includes:
an obtaining module, configured to obtain time reference information of a first signal; and
a determining module, configured to determine synchronization signal block SSB time information based on the time reference information.

According to a third aspect, a terminal is provided. The terminal includes a processor and a memory. The memory stores a program or an instruction that can be run on the processor. When the program or the instruction is executed by the processor, the steps of the method according to the first aspect are implemented.

According to a fourth aspect, a terminal is provided. The terminal includes a processor and a communication interface. The processor is configured to obtain time reference information of a first signal. The processor is further configured to determine synchronization signal block SSB time information based on the time reference information.

According to a fifth aspect, an information determining system is provided. The system includes a terminal and a network side device. The terminal may be configured to perform the steps of the information determining method according to the first aspect.

According to a sixth aspect, a readable storage medium is provided. The readable storage medium stores a program or an instruction. When the program or the instruction is executed by a processor, the steps of the method according to the first aspect are implemented.

According to a seventh aspect, a chip is provided. The chip includes a processor and a communication interface. The communication interface is coupled to the processor. The processor is configured to run a program or an instruction, to implement the method according to the first aspect.

According to an eighth aspect, a computer program/program product is provided. The computer program/program product is stored in a storage medium. The computer program/program product is executed by at least one processor to implement the steps of the method according to the first aspect.

According to a ninth aspect, an electronic device is provided. The electronic device is configured to perform the steps of the method according to the first aspect.

In the embodiments of this application, the terminal obtains the time reference information of the first signal; and the terminal determines the synchronization signal block SSB time information based on the time reference information. In this way, the SSB time information can be determined based on the time reference information of the first signal, a time range for detecting an SSB can be shortened, and power consumption of the terminal can be reduced.

### BRIEF DESCRIPTION OF DRAWINGS

FIG. 1 is a block diagram of a wireless communication system to which embodiments of this application are applicable;

FIG. 2 is a flowchart of an information determining method according to an embodiment of this application;

FIG. 3 is a schematic diagram of a working principle of an LP WUR according to an embodiment of this application;

FIG. 4 is a first schematic diagram of time information for determining an SSB burst set according to an embodiment of this application;

FIG. 5 is a second schematic diagram of time information for determining an SSB burst set according to an embodiment of this application;

FIG. 6 is a schematic structural diagram of a first signal according to an embodiment of this application;

FIG. 7 is a schematic structural diagram of a system frame according to an embodiment of this application;

FIG. 8 is a schematic structural diagram of an information determining apparatus according to an embodiment of this application;

FIG. 9 is a schematic structural diagram of a communication device according to an embodiment of this application; and

FIG. 10 is a schematic structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. An NR system is described in the following description for illustrative purposes, and the NR terminology is used in most of the following description, although these technologies can also be applied to applications other than the NR system application, such as the 6^{th} Generation (6G) communication system.

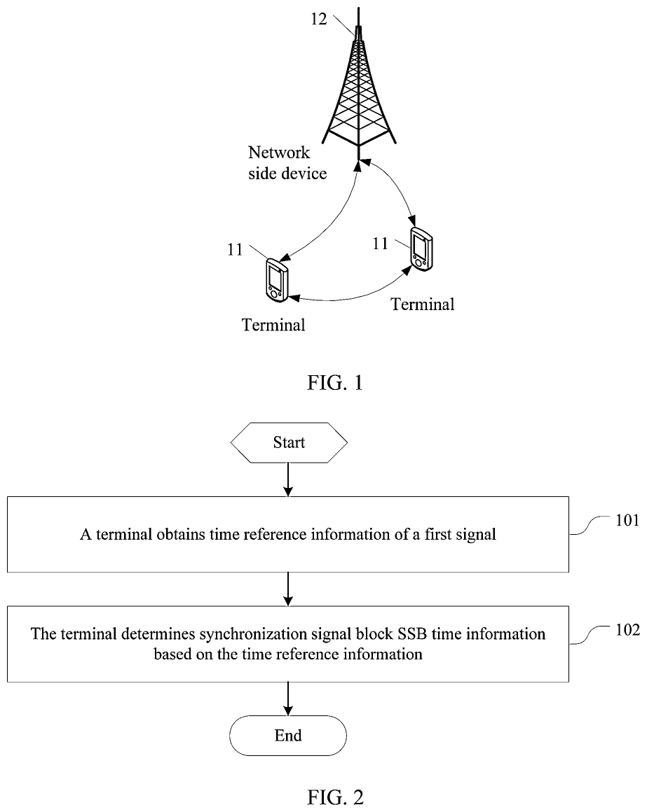

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

With reference to the accompanying drawings, the following describes in detail an information determining method and apparatus, and a terminal provided in the embodiments of this application by using some embodiments and application scenarios thereof.

FIG. 2 is a flowchart of an information determining method according to an embodiment of this application. As shown in FIG. 2, the information determining method includes the following steps.

Step 101: A terminal obtains time reference information of a first signal.

Step 102: The terminal determines synchronization signal block SSB time information based on the time reference information.

In an implementation, the terminal may determine the SSB time information based on the time reference information and the first signal.

In an implementation, a detected time domain position of the first signal may be used as a time domain reference point, and a time domain position of an SSB burst set may be determined based on the time domain reference point and the time reference information. For example, the first signal may be a low-power beacon signal, a keep-alive signal, or a low-power wake-up signal.

In an implementation, the time reference information may include a time offset that is pre-configured or predefined in a specification. For example, the time reference information may include a time offset of a start position of the first signal relative to a start position and/or an end position of a next closest SSB burst set in time, and/or a time offset of an end position of the first signal relative to the start position and/or the end position of the next closest SSB burst set in time. In some alternative embodiments, the time reference information may include a time offset of a start position of a receiving time window of the first signal relative to a start position and/or an end position of a next closest SSB burst set in time, and/or a time offset of an end position of the receiving time window of the first signal relative to the start position and/or the end position of the next closest SSB burst set in time. In some alternative embodiments, the time reference information may include a time offset of a start position and/or an end position of the first signal in a system frame relative to a start position and/or an end position of the system frame, and a time variation of the system frame in which the first signal is located relative to System Frame Number 0 (SFN0), where the time variation is a value of a sequence number of the system frame in which the first signal is located mod 2, and mod is a remainder function. In some alternative embodiments, the time reference information may include a time offset of a start position and/or an end position of a receiving time window of the first signal in a system frame relative to a start position and/or an end position of the system frame, and a time variation of the system frame in which the receiving time window of the first signal is located relative to system frame number 0 (SFN0), where the time variation is a value of a sequence number of the system frame in which the receiving time window of the first signal is located mod 2. A start position of an SSB burst set may be a start position of a first sent SSB in the SSB burst set, and an end position of the SSB burst set may be an end position of a last sent SSB in the SSB burst set.

In an implementation, the time reference information may include a time offset carried in a low-power beacon signal or a keep-alive signal. For example, the time reference information may include a time offset of a start position of the first signal relative to a start position and/or an end position of a next closest SSB in time, and/or a time offset of an end position of the first signal relative to a start position and/or an end position of the next closest SSB in time. In some alternative embodiments, the time reference information may include a time offset of a start position of a receiving time window of the first signal relative to a start position and/or an end position of a next closest SSB in time, and/or a time offset of an end position of the receiving time window of the first signal relative to the start position and/or the end position of the next closest SSB in time.

In an implementation, the time reference information may include a time offset carried in a low-power beacon signal or a keep-alive signal. For example, the time reference information may include a time offset of a start position of the first signal relative to a start position and/or an end position of a next closest SSB burst set in time, and/or a time offset of an end position of the first signal relative to the start position and/or the end position of the next closest SSB burst set in time. In some alternative embodiments, the time reference information may include a time offset of a start position of a receiving time window of the first signal relative to a start position and/or an end position of a next closest SSB burst set in time, and/or a time offset of an end position of the receiving time window of the first signal relative to the start position and/or the end position of the next closest SSB burst set in time. A start position of an SSB burst set may be a start position of a first sent SSB in the SSB burst set, and an end position of the SSB burst set may be an end position of a last sent SSB in the SSB burst set.

In addition, the time reference information may be pre-configured through network signaling or pre-defined in a specification.

In addition, the SSB time information may include time domain position information of an SSB, for example, time domain position information of an actually sent SSB in the SSB burst set and a periodicity of the SSB burst set.

In an implementation, that the terminal determines SSB time information based on the time reference information may include: The terminal determines a start position and/or an end position of at least one SSB burst set based on time information of the start position and/or the end position of the detected first signal, an obtained time offset included in the time reference information of the first signal, and time domain configuration information of the SSB burst set, where the time offset includes the time offset of the start position and/or the end position of the first signal relative to the start position and/or the end position of the next closest SSB burst set in time. A start position of an SSB burst set may be a start position of a first sent SSB in the SSB burst set, and an end position of the SSB burst set may be an end position of a last sent SSB in the SSB burst set.

In an implementation, that the terminal determines SSB time information based on the time reference information may include: The terminal determines a start position and/or an end position of at least one SSB burst set based on time information of the start position and/or the end position of the detected first signal, the obtained time reference information of the first signal, and time domain configuration information of the SSB burst set, where the time reference information includes the time offset of the start position and/or the end position of the first signal in the system frame relative to the start position and/or the end position of the system frame, and the time variation of the system frame in which the first signal is located relative to system frame number 0, and the time variation is the value of the sequence number of the system frame in which first signal is located mod 2.

In an implementation, that the terminal determines SSB time information based on the time reference information may include: The terminal determines a start position and/or an end position of at least one SSB burst set based on time information of the start position and/or the end position of the detected first signal, the obtained time reference information of the first signal, and time domain configuration information of the SSB burst set, where the time reference information includes the time offset of the start position and/or the end position of the receiving time window of the first signal relative to the start position and/or the end position of the next closest SSB burst set in time.

In an implementation, that the terminal determines SSB time information based on the time reference information may include: The terminal determines a start position and/or an end position of at least one SSB burst set based on time information of the start position and/or the end position of the detected first signal, the obtained time reference information of the first signal, and time domain configuration information of the SSB burst set, where the time reference information includes the time offset of the start position and/or the end position of the receiving time window of the first signal in the system frame relative to the start position and/or the end position of the system frame, and the time variation of the system frame in which the start position and/or the end position of the receiving time window of the first signal is located relative to system frame number 0, and the time variation is the value of the sequence number of the system frame in which the first signal is located mod 2.

In an implementation, that the terminal determines SSB time information based on the time reference information may include: The terminal determines a time domain position of one SSB based on time information of the start position and/or the end position of the detected first signal and a time offset included in the obtained time reference information of the first signal, where the time offset is the time offset of the start position and/or the end position of the receiving time window of the first signal relative to the start position and/or the end position of the next closest SSB in time. Further, a time domain start position of another sent SSB in an SSB burst set can be determined based on the time domain position of the SSB and time domain configuration information of the SSB burst set. Further, a start position and/or an end position of at least one SSB burst set can also be determined. A start position of an SSB burst set may be a start position of a first sent SSB in the SSB burst set, and an end position of the SSB burst set may be an end position of a last sent SSB in the SSB burst set.

In an implementation, that the terminal determines SSB time information based on the time reference information may include: The terminal determines a time domain position of one SSB based on time information of the start position and/or the end position of the detected first signal and a time offset included in the obtained time reference information of the first signal, where the time offset is the time offset of the start position and/or the end position of the first signal relative to the start position and/or the end position of the next closest SSB in time. Further, a time domain start position of another sent SSB in an SSB burst set can be determined based on the time domain position of the SSB and time domain configuration information of the SSB burst set. Further, a start position and/or an end position of at least one SSB burst set can also be determined. A start position of an SSB burst set may be a start position of a first sent SSB in the SSB burst set, and an end position of the SSB burst set may be an end position of a last sent SSB in the SSB burst set.

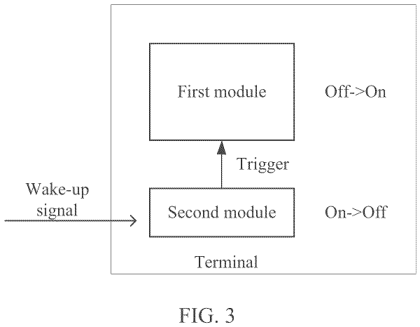

It should be noted that a basic working principle of a Low-Power Wake-Up Receiver/Wake-Up Signal (LP WUR/WUS) is as follows: A receive end includes a first module and a second module. The first module is a main communication module, and is configured to receive communication data transmitted by a transmit end and send communication data. The second module is a low-power module, and is configured to receive a low-power wake-up signal and a low-power beacon signal that are sent by the transmit end. The low-power wake-up signal is used to wake up the main communication module of the receive end. The low-power beacon signal is used to provide time reference information and other information for receiving the low-power wake-up signal, and can also be used to provide wake-up link management. As shown in FIG. 3, the first module is always in an off state when the first module is not awakened by the second module, and no data is sent or received. When downlink data arrives, the second module detects a wake-up signal sent by the transmit end, and the wake-up signal includes information about this terminal. Then, the second module triggers the first module to switch from the off state to an on state to receive and send data. The second module can be enabled continuously or discontinuously. When the second module is enabled, the second module can receive the low-power wake-up signal and the low-power beacon signal.

In an NR system, a low-power wake-up module/receiver and a low-power wake-up signal may be introduced. When a terminal is idle, a main communication module/receiver can be disabled or set to a deep sleep state, and only a low-power wake-up module/receiver is used to monitor a low-power wake-up signal, to reduce power consumption of the terminal. When the main communication module/receiver is awakened, an SSB needs to be detected to obtain downlink time information and AGC adjustment, time-frequency tracking, CFO compensation, and the like. The main communication module/receiver cannot maintain accurate time information while disabled or in the deep sleep state. Therefore, after being awakened, the main communication module/receiver cannot determine a time domain position of the SSB, and needs to blindly detect the SSB within at least one SSB burst set periodicity. Consequently, power consumption is high.

In this embodiment of this application, SSB time domain position reference information is provided through the first signal, to assist the terminal in determining an SSB position when detecting an SSB for the first time after being awakened. In this way, blind detection time can be shortened, and therefore power consumption can be reduced.

In this embodiment of this application, the terminal obtains the time reference information of the first signal; and the terminal determines the synchronization signal block SSB time information based on the time reference information. In this way, the SSB time information can be determined based on the time reference information of the first signal, a time range for detecting an SSB can be shortened, and power consumption of the terminal can be reduced.

In some embodiments, the SSB time information includes time information of an SSB burst set.

The time information of the SSB burst set may include a start position and/or an end position of any sent SSB in the SSB burst set. For example, the time information of the SSB burst set may include a start position of a first sent SSB in the SSB burst set, and/or an end position of a last sent SSB in the SSB burst set. In some alternative embodiments, the time information of the SSB burst set may include a start position of any candidate position in the SSB burst set, and the like. The time information of the SSB burst set is not limited in this embodiment.

In this implementation, the SSB time information includes the time information of the SSB burst set, and the terminal determines the time information of the SSB burst set based on the time reference information of the first signal, so that the SSB can be detected based on the time information of the SSB burst set, and the power consumption of the terminal can be reduced.

In some embodiments, the first signal includes at least one of the following:
a low-power beacon signal;
a keep-alive signal; and
a low-power wake-up signal.

In this implementation, at least one of the low-power beacon signal, the keep-alive signal, and the low-power wake-up signal is used to assist the terminal in detecting the SSB for the first time after being awakened, so that the time range for detecting the SSB can be shortened, and the power consumption of the terminal can be reduced.

In some embodiments, the time reference information includes at least one of the following:
first time offset information of the first signal relative to an SSB; and
second time offset information of the first signal relative to a system frame.

A time unit of the first time offset information may be: slot, symbol, ms, subframe, half-frame, frame, and the like. This is not limited in this embodiment. A time unit of the second time offset information may be: slot, symbol, ms, subframe, half-frame, frame, and the like. This is not limited in this embodiment.

In some embodiments, the first time offset information includes at least one of the following:
a time offset of a start position corresponding to the first signal relative to a start position of the SSB;
a time offset of the start position corresponding to the first signal relative to an end position of the SSB;
a time offset of an end position corresponding to the first signal relative to the start position of the SSB; and
a time offset of the end position corresponding to the first signal relative to the end position of the SSB.

The start position of the SSB may be a start position of an SSB burst set, and the start position of the SSB burst set is a start position of a first sent SSB in the SSB burst set. In some alternative embodiments, the start position of the SSB may be a start position of any sent SSB in an SSB burst set.

In addition, the end position of the SSB may be an end position of the SSB burst set, and the end position of the SSB burst set is an end position of a last sent SSB in the SSB burst set. In some alternative embodiments, the end position of the SSB may be an end position of any sent SSB in the SSB burst set.

In an implementation, the first time offset information includes at least one of the following:
a time offset of the start position corresponding to the first signal relative to a start position of a next closest SSB burst set in time;
a time offset of the start position corresponding to the first signal relative to an end position of the next closest SSB burst set in time;
a time offset of the end position corresponding to the first signal relative to the start position of the next closest SSB burst set in time; and
a time offset of the end position corresponding to the first signal relative to the end position of the next closest SSB burst set in time.

That the start position of the SSB is the start position of the first sent SSB in the SSB burst set, and the end position of the SSB is the end position of the last sent SSB in the SSB burst set is used as an example for description.

In an implementation, the start position corresponding to the first signal includes the start position of the first signal, and the first time offset information includes the time offset of the start position corresponding to the first signal relative to the start position of the SSB, so that the start position of the first sent SSB in the SSB burst set may be determined based on the start position of the first signal and the first time offset information. For example, the time offset may be added to the start position of the first signal to obtain the start position of the first sent SSB in the SSB burst set, and then a time domain start position of another sent SSB in the SSB burst set may be obtained based on time domain configuration information of the SSB burst set. For example, the time domain start position of the another sent SSB in the SSB burst set may be determined based on the start position of the first sent SSB and a time interval between start positions of two adjacent SSBs.

In an implementation, the end position corresponding to the first signal includes the end position of the first signal, and the first time offset information includes the time offset of the end position corresponding to the first signal relative to the end position of the SSB, so that the end position of the last sent SSB in the SSB burst set may be determined based on the end position of the first signal and the first time offset information. For example, the time offset may be added to the end position of the first signal to obtain the end position of the last sent SSB in the SSB burst set, and then a time domain start position of the last sent SSB and a time domain start position of another sent SSB in the SSB burst set may be obtained based on time domain configuration information of the SSB burst set.

In an implementation, the start position corresponding to the first signal includes the start position of the first signal, and the first time offset information includes the time offset of the start position corresponding to the first signal relative to the end position of the SSB, so that the end position of the last sent SSB in the SSB burst set may be determined based on the start position of the first signal and the first time offset information. For example, the time offset may be added to the start position of the first signal to obtain the end position of the last sent SSB in the SSB burst set, and then a time domain start position of the last sent SSB and a time domain start position of another sent SSB in the SSB burst set may be obtained based on time domain configuration information of the SSB burst set.

In an implementation, the start position corresponding to the first signal includes the start position of the first signal, and the first time offset information includes the time offset of the end position corresponding to the first signal relative to the start position of the SSB, so that the start position of the first sent SSB in the SSB burst set may be determined based on the end position of the first signal and the first time offset information. For example, the time offset may be added to the end position of the first signal to obtain the start position of the first sent SSB in the SSB burst set, and then a time domain start position of another sent SSB in the SSB burst set may be obtained based on time domain configuration information of the SSB burst set.

In an implementation, the start position corresponding to the first signal includes the start position of the receiving time window of the first signal, and the first time offset information includes the time offset of the start position corresponding to the first signal relative to the start position of the SSB. In a case that the first signal carries a sequence number of a candidate position in the receiving time window, the start position of the receiving time window of the first signal may be determined based on the start position of the received first signal and sending candidate position information of the first signal. Therefore, the start position of the first sent SSB in the SSB burst set may be determined based on the start position of the receiving time window of the first signal and the first time offset information. For example, the time offset may be added to the start position of the receiving time window of the first signal to obtain the start position of the first sent SSB in the SSB burst set, and then a time domain start position of another sent SSB in the SSB burst set may be obtained based on time domain configuration information of the SSB burst set.

In an implementation, the end position corresponding to the first signal includes the end position of the first signal, and the first time offset information includes the time offset of the end position corresponding to the first signal relative to the end position of the SSB. In a case that the first signal carries a sequence number of a candidate position in the receiving time window, the end position of the receiving time window of the first signal may be determined based on the end position of the received first signal and sending candidate position information of the first signal. Therefore, the end position of the last sent SSB in the SSB burst set may be determined based on the end position of the receiving time window of the first signal and the first time offset information. For example, the time offset may be added to the end position of the receiving time window of the first signal to obtain the end position of the last sent SSB in the SSB burst set, and then a time domain start position of the last sent SSB and a time domain start position of another sent SSB in the SSB burst set may be obtained based on time domain configuration information of the SSB burst set.

In some embodiments, the second time offset information includes at least one of the following:
a time offset of a start position corresponding to the first signal relative to a start position of a first system frame;
a time offset of an end position corresponding to the first signal relative to the start position of the first system frame;
a time offset of the start position corresponding to the first signal relative to an end position of the first system frame; and
a time offset of the end position corresponding to the first signal relative to the end position of the first system frame.

The first system frame is the system frame in which the first signal is located.

A start position and/or an end position of the first system frame may be determined based on the second time offset information and the start position and/or the end position corresponding to the first signal. For example, the start position of the first system frame may be determined based on either the time offset of the start position corresponding to the first signal relative to the start position of the first system frame or the time offset of the end position corresponding to the first signal relative to the start position of the first system frame, and the end position of the first system frame may be determined based on either the time offset of the start position corresponding to the first signal relative to the end position of the first system frame and the time offset of the end position corresponding to the first signal relative to the end position of the first system frame.

In addition, a relationship between a frame identifier of the first system frame and a frame identifier of a preset system frame may be determined based on obtained first indication information, and the preset system frame may be system frame number 0. For example, it may be determined that the frame identifier of the first system frame is an even number or an odd number. Based on the obtained time domain configuration information of the SSB burst set, for example, a sending periodicity of the SSB burst set, and a frame identifier that is of a system frame in which the at least one SSB is located and that is detected by the terminal when the terminal first accesses a cell, it may be determined that a frame identifier of a system frame in which the SSB burst set is located is an odd number or an even number. In a case that it is determined based on the sending periodicity of the SSB burst set and a length of the system frame that the frame identifier of the system frame in which the SSB burst set is located is an even number, when the frame identifier of the first system frame is an even number, the SSB may be detected in the first system frame; and when the frame identifier of the first system frame is an odd number, the SSB may be detected in a next system frame of the first system frame. For example, in a case that the terminal detects that a frame identifier of a frame in which an SSB is located is 10 when the terminal first accesses the cell, the sending periodicity of the SSB burst set is 20 ms, and the length of the system frame is 10 ms, the frame identifier of the system frame in which the SSB burst set is located is an even number. Further, a time offset of the start position and/or the end position of the SSB burst set from the system frame may be determined based on a position of at least one sent SSB in the SSB burst set and a time offset of the at least one SSB from the system frame, so that the start position and/or the end position of the SSB burst set may be determined based on the start position and/or the end position of the first system frame and the time offset of the start position and/or the end position of the SSB burst set from the system frame. The position of the at least one SSB in the SSB burst set may include a sequence number of a candidate position of the at least one SSB in the SSB burst set. For example, a time offset of the start position of the SSB burst set from the system frame may be determined based on the sequence number of the candidate position, an interval between start positions of two adjacent candidate positions, and the time offset of the at least one SSB from the system frame.

In some embodiments, the second time offset information further includes the first indication information, and the first indication information indicates the relationship between the frame identifier of the first system frame and the frame identifier of the preset system frame.

The preset system frame may be system frame number 0, and the frame identifier of the preset system frame may be 0. The first indication information may be a value of the frame identifier of the first system frame mod 2. The frame identifier may also be referred to as a frame sequence number.

In some embodiments, the start position corresponding to the first signal includes the start position of the first signal; and/or the end position corresponding to the first signal includes the end position of the first signal.

In some embodiments, the start position corresponding to the first signal includes the start position of the receiving time window of the first signal; and/or the end position corresponding to the first signal includes the end position of the receiving time window of the first signal.

The receiving time window of the first signal is a time range for receiving the first signal within a first signal periodicity.

In some embodiments, the first time offset information further includes time information of at least one first signal within the receiving time window of the first signal.

The time reference information of the first signal may include a time offset/time offsets of the start position and/or the end position of the receiving time window of the first signal relative to the start position and/or the end position of the next closest SSB burst set in time. The time information of the SSB burst set may be determined based on the time information of the at least one first signal within the receiving time window of the first signal, and the time offset included in the time reference information of the first signal.

In some embodiments, the time reference information is pre-configured through signaling; or the time reference information is pre-defined in the specification; or the time reference information is carried in the first signal.

In some embodiments, the time reference information is carried in at least one of a preamble and a data part of the first signal.

In this implementation, the time reference information is carried in at least one of the preamble and the data part of the first signal, so that the SSB time information can be determined based on at least one of the preamble and the data part of the first signal, the time range for detecting the SSB can be shortened, and the power consumption of the terminal can be reduced.

In some embodiments, the time information of the SSB burst set includes the start position of the first sent SSB in the SSB burst set; and/or the time information of the SSB burst set includes the end position of the last sent SSB in the SSB burst set.

In some embodiments, the time reference information further includes:
time domain configuration information of the first signal.

The time domain configuration information of the first signal includes at least one of the following:
a sending periodicity;
a receiving time window length; and
information about a candidate position in the receiving time window.

The time domain configuration information of the first signal may be pre-configured through network signaling or pre-defined in the specification. The information about the candidate position in the receiving time window may include a sequence number of the candidate position in the receiving time window.

In an implementation, the time reference information of the first signal may include the time offset/time offsets of the start position and/or the end position of the receiving time window of the first signal relative to the start position and/or the end position of the next closest SSB burst set in time. In a case that the first signal carries the sequence number of the candidate position in the receiving time window, the terminal may determine the start position and/or the end position of the receiving time window of the first signal based on the information about the candidate position in the receiving time window in the time domain configuration information of the first signal, and therefore determine the start position and/or the end position of the SSB burst set based on the start position and/or the end position of the receiving time window of the first signal and the time reference information. For example, the information about the candidate position in the receiving time window indicates that the receiving time window includes eight candidate positions, and an interval between start positions of two adjacent candidate positions is 1 ms. In a case that the sequence number of the candidate position of the received first signal is 2, the start position of the receiving time window of the first signal is the start position of the received first signal plus 1 ms, and then the start position of the SSB burst set may be determined based on the start position of the receiving time window of the first signal and the time reference information. A start position of an SSB burst set may be a start position of a first sent SSB in the SSB burst set, and an end position of the SSB burst set may be an end position of a last sent SSB in the SSB burst set.

In an implementation, the time reference information of the first signal may include the time offset/time offsets of the start position and/or the end position of the receiving time window of the first signal relative to the start position and/or the end position of the next closest SSB burst set in time. In a case that the first signal does not carry the sequence number of the candidate position in the receiving time window, the terminal may determine a receiving time window extension range based on the receiving time window length and the start position and/or the end position of the received first signal, and determine a receiving time window range of at least one SSB burst set based on the receiving time window extension range and the time reference information. For example, the start position of the first signal is a point a, the receiving time window length is b, and the time offset included in the time reference information is c. In this case, the receiving time window extension range may be (a−b, a+b), and the receiving time window range of the at least one SSB burst set may be (a−b+c, a+b+c). A start position of an SSB burst set may be a start position of a first sent SSB in the SSB burst set, and an end position of the SSB burst set may be an end position of a last sent SSB in the SSB burst set.

In this implementation, the time domain configuration information of the first signal is used to assist the terminal in detecting the SSB for the first time after being awakened, so that the time range for detecting the SSB can be shortened, and the power consumption of the terminal can be reduced.

In some embodiments, the time reference information further includes:
time domain configuration information of an SSB burst set.

The time domain configuration information of the SSB burst set includes at least one of the following:
a periodicity of the SSB burst set; and
position information of at least one sent SSB in the SSB burst set.

The time domain configuration information of the SSB burst set may be obtained through SIB1.

In an implementation, the time domain configuration information of the SSB burst set may be as follows:

| | |
|---|---|
| { | |
| ServingCellConfigCommonSIB ::= | SEQUENCE { |
| downlinkConfigCommon | DownlinkConfigCommonSIB, |
| uplinkConfigCommon | UplinkConfigCommonSIB |
| OPTIONAL, -- Need R | |
| supplementaryUplink | UplinkConfigCommonSIB |
| OPTIONAL, -- Need R | |
| n-TimingAdvanceOffset | ENUMERATED {n0, n25600, |
| n39936} | |
| OPTIONAL, -- Need S | |
| ssb-PositionsInBurst | SEQUENCE { |
| inOneGroup | BIT STRING (SIZE (8)), |
| groupPresence | BIT STRING (SIZE (8)), |
| OPTIONAL, -- Cond FR2-Only | |
| }, | |
| ssb-PeriodicityServingCell | ENUMERATED {ms5, ms10, |
| ms20, ms40, ms80, ms160}, | |
| tdd-UL-DL-ConfigurationCommon | TDD-UL-DL-ConfigCommon |
| OPTIONAL, -- Cond TDD | |
| } | |

The parameter ssb-PositionsInBurst may indicate the position information of the SSB in the SSB burst set. The parameter ssb-PeriodicityServingCell may indicate the periodicity of the SSB burst set.

In this implementation, the time domain configuration information of the SSB burst set is used to assist the terminal in detecting the SSB for the first time after being awakened, so that the time range for detecting the SSB can be shortened, and the power consumption of the terminal can be reduced.

The following describes the information determining method in the embodiments of this application by using four embodiments.

### Embodiment 1

A terminal obtains time reference information of a first signal. The time reference information of the first signal may be pre-configured through network signaling or pre-defined in a specification. The time reference information of the first signal includes a time offset/time offsets of a start position and/or an end position of the first signal relative to a start position and/or an end position of a next closest SSB burst set in time. The start position of the SSB burst set is a start position of a first actually sent SSB in the SSB burst set, and the end position is an end position of a last actually sent SSB in the SSB burst set. The first signal may be any one of a low-power beacon signal, a keep-alive signal, or a low-power wake-up signal.

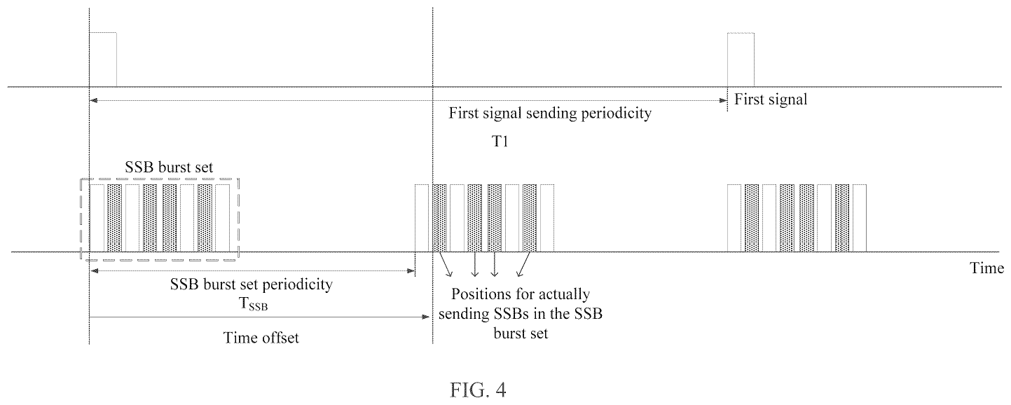

The terminal uses a low-power receiving module to detect the first signal and obtain time information of the start position and/or the end position of the first signal. The terminal may determine a start position and/or an end position of at least one SSB burst set based on the time information of the start position and/or the end position of the first signal and the time offset included in the time reference information of the first signal. As shown in FIG. 4, the terminal may add the time offset to the start position of the first signal to obtain the start position of the SSB burst set.

In an implementation, a sending periodicity of the first signal may be set to an integer multiple M of a sending periodicity of the SSB burst set, where M≥1.

In an implementation, when the first signal is the low-power beacon signal or the keep-alive signal, the terminal may detect the first signal through the low-power receiving module when a main communication module is disabled or enabled, and obtain the time information of the start position and/or the end position of the first signal.

### Embodiment 2

A terminal obtains time reference information of a first signal. The time reference information of the first signal is carried in the first signal, for example, may be carried in at least one of a preamble and a data part of the first signal. The time reference information of the first signal includes a time offset/time offsets of a start position and/or an end position of the first signal relative to a start position and/or an end position of a next closest SSB in time. The first signal may be any one of a low-power beacon signal, a keep-alive signal, or a low-power wake-up signal.

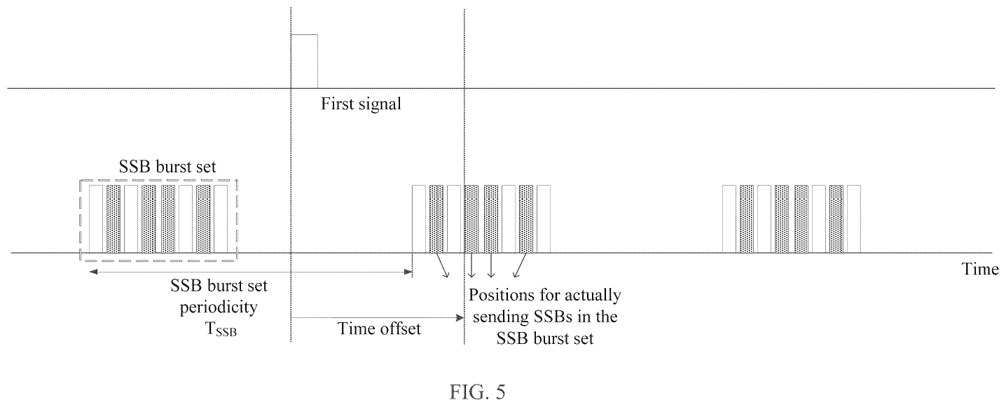

The terminal uses a low-power receiving module to detect the first signal and obtain time information of the start position and/or the end position of the first signal. The terminal may determine a start position and/or an end position of at least one SSB based on the time information of the start position and/or the end position of the first signal and the time offset included in the time reference information of the first signal. As shown in FIG. 5, the terminal may add the time offset to the start position of the first signal to obtain the start position of the SSB.

In an implementation, when the first signal is the low-power beacon signal or the keep-alive signal, the terminal may detect the first signal through the low-power receiving module when a main communication module is disabled or enabled, and obtain the time information of the start position and/or the end position of the first signal.

It should be noted that methods for carrying the time reference information of the first signal in at least one of the preamble and the data part of the first signal may include:

Method 1: The data part carries a value of the time offset, and a unit of the time offset is: slot, symbol, ms, subframe, half-frame, frame, and the like. This is not limited in this embodiment.

Method 2: A set of time offset values are pre-configured or defined, a numerical sequence number is carried in the preamble or the data part, and the numerical sequence number uniquely identifies one time offset value in the set of time offset values.

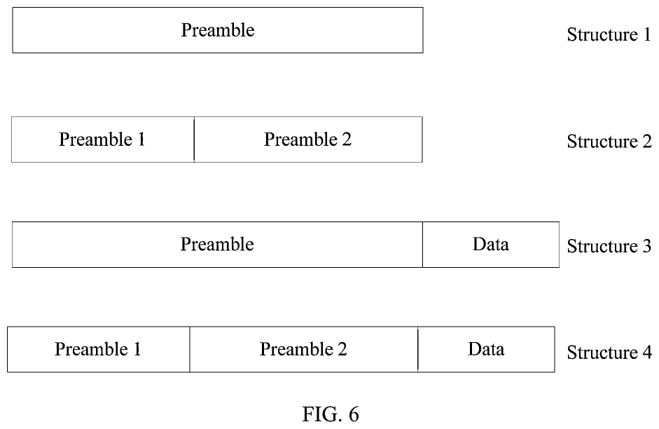

In addition, a signal structure of the first signal is any one of signal structures shown in FIG. 6.

### Embodiment 3

A terminal obtains time reference information of a first signal. The time reference information of the first signal is pre-configured through network signaling or pre-defined in a specification. The time reference information of the first signal includes a time offset/time offsets of a start position and/or an end position of the first signal in a system frame relative to a start position and/or an end position of the system frame. The time reference information of the first signal may also include a time variation of the system frame in which the first signal is located relative to system frame number 0 (SFN0), and the time variation is a value of a sequence number of the system frame in which the first signal is located mod 2, and mod is a remainder function.

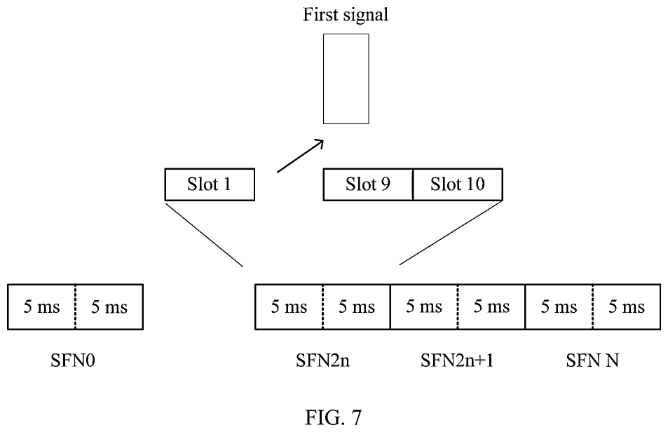

The terminal uses a low-power receiving module to detect the first signal and obtain time information of the start position and/or the end position of the first signal, and determines, based on the time offset included in the time reference information of the first signal, the start position and/or the end position of the system frame in which the first signal is located. Then, the terminal determines, based on the time variation included in the time reference information of the first signal, that is, the value of the sequence number of the system frame in which the first signal is located mod 2, whether the sequence number of the system frame in which the first signal is located is an even number or an odd number. As shown in FIG. 7, the sequence number of the system frame in which the first signal is located is an even number. Further, a start position and/or an end position of at least one SSB burst set are/is determined based on time domain configuration information of the SSB burst set received by the terminal, for example, a sending periodicity of the SSB burst set and a position of at least one sent SSB in the SSB burst set.

The start position of the SSB burst set is a start position of a first actually sent SSB in the SSB burst set, and the end position is an end position of a last actually sent SSB in the SSB burst set. The first signal may be any one of a low-power beacon signal, a keep-alive signal, or a low-power wake-up signal.

In addition, when the first signal is the low-power beacon signal or the keep-alive signal, the terminal may detect the first signal through the low-power receiving module when a main communication module is disabled or enabled, and obtain the time information of the start position and/or the end position of the first signal.

### Embodiment 4

A terminal obtains time reference information of a first signal. The time reference information of the first signal is pre-configured through network signaling or pre-defined in a specification. The time reference information of the first signal includes a time offset/time offsets of a start position and/or an end position of a receiving time window of the first signal relative to a start position and/or an end position of a next closest SSB burst set in time. The start position of the SSB burst set is a start position of a first actually sent SSB in the SSB burst set, and the end position is an end position of a last actually sent SSB in the SSB burst set. The first signal may be any one of a low-power beacon signal, a keep-alive signal, or a low-power wake-up signal.

The terminal uses a low-power receiving module to detect the first signal and obtain time information of a start position and/or an end position of the first signal, and determines, based on the time offset included in the time reference information of the first signal, a start position and/or an end position of at least one SSB burst set. Methods for determining the start position and/or the end position of the at least one SSB burst set include, but are not limited to, one of the following:

Method 1: The first signal carries a sequence number of a candidate position in the receiving time window, and the terminal determines the start position and/or the end position of the receiving time window of the first signal based on pre-received sending candidate position information of the first signal included in the receiving time window of the first signal, and the obtained time information of the start position and/or the end position of the first signal. The terminal determines the start position and/or the end position of the at least one SSB burst set based on the start position and/or the end position of the receiving time window of the first signal and the time offset included in the time reference information of the first signal.

Method 2: The first signal does not carry a sequence number of a candidate position in the receiving time window, and the terminal determines a receiving time window range of the at least one SSB burst set based on the obtained time information of the start position and/or the end position of the first signal, a pre-received receiving time window length of the first signal, and the time offset included in the time reference information of the first signal.

In addition, when the first signal is the low-power beacon signal or the keep-alive signal, the terminal may detect the first signal through the low-power receiving module when a main communication module is disabled or enabled, and obtain the time information of the start position and/or the end position of the first signal.

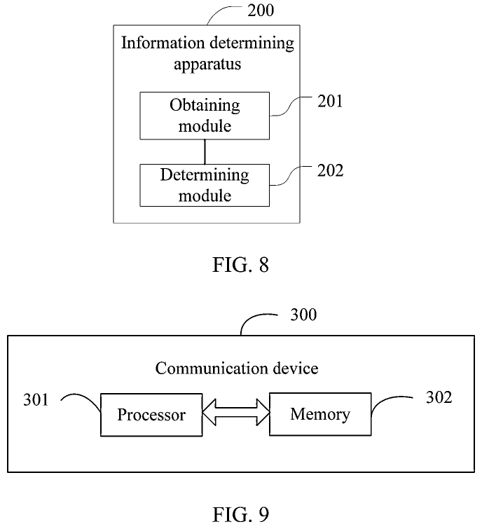

FIG. 8 is a structural diagram of an information determining apparatus according to an embodiment of this application. A terminal may include the information determining apparatus. As shown in FIG. 8, the information determining apparatus 200 includes:
an obtaining module 201, configured to obtain time reference information of a first signal; and
a determining module 202, configured to determine synchronization signal block SSB time information based on the time reference information.

In some embodiments, the SSB time information includes time information of an SSB burst set.

In some embodiments, the first signal includes at least one of the following:
a low-power beacon signal;
a keep-alive signal; and
a low-power wake-up signal.

In some embodiments, the time reference information includes at least one of the following:
first time offset information of the first signal relative to an SSB; and
second time offset information of the first signal relative to a system frame.

In some embodiments, the first time offset information includes at least one of the following:
a time offset of a start position corresponding to the first signal relative to a start position of the SSB;
a time offset of the start position corresponding to the first signal relative to an end position of the SSB;
a time offset of an end position corresponding to the first signal relative to the start position of the SSB; and
a time offset of the end position corresponding to the first signal relative to the end position of the SSB.

In some embodiments, the second time offset information includes at least one of the following:
a time offset of a start position corresponding to the first signal relative to a start position of a first system frame;
a time offset of an end position corresponding to the first signal relative to the start position of the first system frame;
a time offset of the start position corresponding to the first signal relative to an end position of the first system frame; and
a time offset of the end position corresponding to the first signal relative to the end position of the first system frame.

The first system frame is a system frame in which the first signal is located.

In some embodiments, the second time offset information further includes first indication information, and the first indication information indicates a relationship between a frame identifier of the first system frame and a frame identifier of a preset system frame.

In some embodiments, the start position corresponding to the first signal includes a start position of the first signal; and/or
the end position corresponding to the first signal includes an end position of the first signal.

In some embodiments, the start position corresponding to the first signal includes a start position of a receiving time window of the first signal; and/or the end position corresponding to the first signal includes an end position of the receiving time window of the first signal.

In some embodiments, the first time offset information further includes time information of at least one first signal within the receiving time window of the first signal.

In some embodiments, the time reference information is pre-configured through signaling; or the time reference information is pre-defined in a specification; or the time reference information is carried in the first signal.

In some embodiments, the time reference information is carried in at least one of a preamble and a data part of the first signal.

In some embodiments, the time information of the SSB burst set includes a start position of a first sent SSB in the SSB burst set; and/or the time information of the SSB burst set includes an end position of a last sent SSB in the SSB burst set.

In some embodiments, the time reference information further includes:
time domain configuration information of the first signal.

The time domain configuration information of the first signal includes at least one of the following:
a sending periodicity;
a receiving time window length; and
information about a candidate position in the receiving time window.

In some embodiments, the time reference information further includes:
time domain configuration information of an SSB burst set.

The time domain configuration information of the SSB burst set includes at least one of the following:
a periodicity of the SSB burst set; and
position information of at least one sent SSB in the SSB burst set.

With the information determining apparatus in this embodiment of this application, the SSB time information can be determined based on the time reference information of the first signal, a time range for detecting an SSB can be shortened, and power consumption of the terminal can be reduced.

The information determining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The information determining apparatus provided in this embodiment of this application can implement the processes implemented in the method embodiment of FIG. 2, and achieve a same technical effect. To avoid repetition, details are not described herein again.

For example, as shown in FIG. 9, an embodiment of this application further provides a communication device 300, including a processor 301 and a memory 302, and the memory 302 stores a program or an instruction that can be run on the processor 301. For example, in a case that the communication device 300 is a terminal, when the program or the instruction is executed by the processor 301, the steps in the foregoing embodiments of the information determining method are implemented, and a same technical effect can be achieved. To avoid repetition, details are not described herein again.

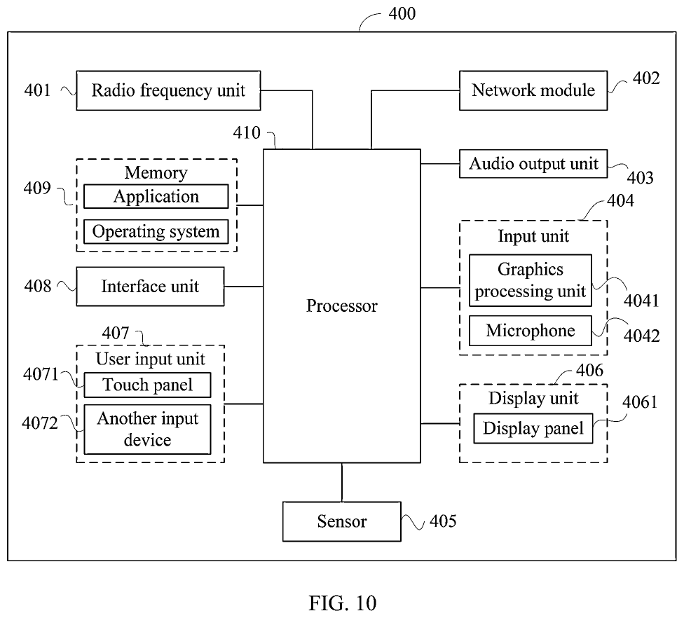

An embodiment of this application further provides a terminal. The terminal includes a processor and a communication interface. The processor is configured to obtain time reference information of a first signal. The processor is further configured to determine synchronization signal block SSB time information based on the time reference information. The embodiment of the terminal corresponds to the embodiment of the information determining method, each implementation process and implementation of the embodiment of the information determining method can be applied to the embodiment of the terminal, and a same technical effect can be achieved. For example, FIG. 10 is a schematic diagram of a hardware structure of a terminal according to an embodiment of this application.

The terminal 400 includes but is not limited to at least a part of components such as a radio frequency unit 401, a network module 402, an audio output unit 403, an input unit 404, a sensor 405, a display unit 406, a user input unit 407, an interface unit 408, a memory 409, and a processor 410.

A person skilled in the art can understand that the terminal 400 may further include a power supply (such as a battery) that supplies power to each component. The power supply may be logically connected to the processor 410 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 404 may include a Graphics Processing Unit (GPU) 4041 and a microphone 4042. The graphics processing unit 4041 processes image data of a static picture or a video obtained by an image capture apparatus (for example, a camera) in a video capture mode or an image capture mode. The display unit 406 may include a display panel 4061, and the display panel 4061 may be configured in a form of a liquid crystal display, an organic light-emitting diode, or the like. The user input unit 407 includes at least one of a touch panel 4071 and another input device 4072. The touch panel 4071 is also referred to as a touchscreen. The touch panel 4071 may include two parts: a touch detection apparatus and a touch controller. The another input device 4072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 401 may transmit the downlink data to the processor 410 for processing. In addition, the radio frequency unit 401 may send uplink data to the network side device. Generally, the radio frequency unit 401 includes but is not limited to an antenna, an amplifier, a transceiver, a coupler, a low noise amplifier, a duplexer, and the like.

The memory 409 may be configured to store a software program or an instruction and various data. The memory 409 may mainly include a first storage area for storing a program or an instruction and a second storage area for storing data. The first storage area may store an operating system, and an application or an instruction required by at least one function (for example, a sound playing function or an image playing function). In addition, the memory 409 may be a volatile memory or a non-volatile memory, or the memory 409 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 409 in this embodiment of this application includes but is not limited to these memories and any memory of another proper type.

The processor 410 may include one or more processing units. In some embodiments, an application processor and a modem processor are integrated into the processor 410. The application processor mainly processes an operating system, a user interface, an application, or the like. The modem processor mainly processes a wireless communication signal, for example, a baseband processor. It may be understood that, in some alternative embodiments, the modem processor may not be integrated into the processor 410.

The processor 410 is configured to: obtain time reference information of a first signal.

The processor 410 is further configured to: determine synchronization signal block SSB time information based on the time reference information.

In some embodiments, the SSB time information includes time information of an SSB burst set.

In some embodiments, the first signal includes at least one of the following:
a low-power beacon signal;
a keep-alive signal; and
a low-power wake-up signal.

In some embodiments, the time reference information includes at least one of the following:
first time offset information of the first signal relative to an SSB; and
second time offset information of the first signal relative to a system frame.

In some embodiments, the first time offset information includes at least one of the following:
a time offset of a start position corresponding to the first signal relative to a start position of the SSB;
a time offset of the start position corresponding to the first signal relative to an end position of the SSB;
a time offset of an end position corresponding to the first signal relative to the start position of the SSB; and
a time offset of the end position corresponding to the first signal relative to the end position of the SSB.

In some embodiments, the second time offset information includes at least one of the following:
a time offset of a start position corresponding to the first signal relative to a start position of a first system frame;
a time offset of an end position corresponding to the first signal relative to the start position of the first system frame;
a time offset of the start position corresponding to the first signal relative to an end position of the first system frame; and
a time offset of the end position corresponding to the first signal relative to the end position of the first system frame.

The first system frame is a system frame in which the first signal is located.

In some embodiments, the second time offset information further includes first indication information, and the first indication information indicates a relationship between a frame identifier of the first system frame and a frame identifier of a preset system frame.

In some embodiments, the start position corresponding to the first signal includes a start position of the first signal; and/or the end position corresponding to the first signal includes an end position of the first signal.

In some embodiments, the start position corresponding to the first signal includes a start position of a receiving time window of the first signal; and/or the end position corresponding to the first signal includes an end position of the receiving time window of the first signal.

In some embodiments, the first time offset information further includes time information of at least one first signal within the receiving time window of the first signal.

In some embodiments, the time reference information is pre-configured through signaling; or the time reference information is pre-defined in a specification; or the time reference information is carried in the first signal.

In some embodiments, the time reference information is carried in at least one of a preamble and a data part of the first signal.

In some embodiments, the time information of the SSB burst set includes a start position of a first sent SSB in the SSB burst set; and/or the time information of the SSB burst set includes an end position of a last sent SSB in the SSB burst set.

In some embodiments, the time reference information further includes:
time domain configuration information of the first signal.

The time domain configuration information of the first signal includes at least one of the following:
a sending periodicity;
a receiving time window length; and
information about a candidate position in the receiving time window.

In some embodiments, the time reference information further includes:
time domain configuration information of an SSB burst set.

The time domain configuration information of the SSB burst set includes at least one of the following:
a periodicity of the SSB burst set; and
position information of at least one sent SSB in the SSB burst set.

An embodiment of this application further provides a readable storage medium. The readable storage medium stores a program or an instruction, and the program or the instruction is executed by a processor to implement the processes of the foregoing information determining method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information determining method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing information determining method embodiment, and a same technical effect can be achieved. To avoid repetition, details are not described herein again.

An embodiment of this application further provides an information determining system. The system includes a terminal and a network side device. The terminal may be configured to perform the steps of the information determining method described above.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. An information determining method, comprising:
obtaining, by a terminal, time reference information of a first signal; and
determining, by the terminal, Synchronization Signal Block (SSB) time information based on the time reference information.

2. The information determining method according to claim 1, wherein the SSB time information comprises time information of an SSB burst set.

3. The information determining method according to claim 1, wherein the first signal comprises at least one of the following:
a low-power beacon signal;
a keep-alive signal; or
a low-power wake-up signal.

4. The information determining method according to claim 1, wherein the time reference information comprises at least one of the following:
first time offset information of the first signal relative to an SSB; or
second time offset information of the first signal relative to a system frame.

5. The information determining method according to claim 4, wherein the first time offset information comprises at least one of the following:
a time offset of a start position corresponding to the first signal relative to a start position of the SSB;
a time offset of the start position corresponding to the first signal relative to an end position of the SSB;
a time offset of an end position corresponding to the first signal relative to the start position of the SSB; or
a time offset of the end position corresponding to the first signal relative to the end position of the SSB.

6. The information determining method according to claim 4, wherein the second time offset information comprises at least one of the following:
a time offset of a start position corresponding to the first signal relative to a start position of a first system frame;
a time offset of an end position corresponding to the first signal relative to the start position of the first system frame;
a time offset of the start position corresponding to the first signal relative to an end position of the first system frame; or
a time offset of the end position corresponding to the first signal relative to the end position of the first system frame, wherein
the first system frame is a system frame in which the first signal is located.

7. The information determining method according to claim 6, wherein the second time offset information further comprises first indication information, and the first indication information indicates a relationship between a frame identifier of the first system frame and a frame identifier of a preset system frame.

8. The information determining method according to claim 5, wherein the start position corresponding to the first signal comprises a start position of the first signal; or
the end position corresponding to the first signal comprises an end position of the first signal.

9. The information determining method according to claim 5, wherein the start position corresponding to the first signal comprises a start position of a receiving time window of the first signal; or
the end position corresponding to the first signal comprises an end position of the receiving time window of the first signal.

10. The information determining method according to claim 9, wherein the first time offset information further comprises time information of at least one first signal within the receiving time window of the first signal.

11. The information determining method according to claim 1, wherein the time reference information is pre-configured through signaling; or the time reference information is pre-defined in a specification; or the time reference information is carried in the first signal.

12. The information determining method according to claim 11, wherein the time reference information is carried in at least one of a preamble and a data part of the first signal.

13. The information determining method according to claim 2, wherein the time information of the SSB burst set comprises a start position of a first sent SSB in the SSB burst set; or
the time information of the SSB burst set comprises an end position of a last sent SSB in the SSB burst set.

14. The information determining method according to claim 4, wherein the time reference information further comprises:
time domain configuration information of the first signal, wherein
the time domain configuration information of the first signal comprises at least one of the following:
a sending periodicity;
a receiving time window length; or
information about a candidate position in the receiving time window.

15. The information determining method according to claim 4, wherein the time reference information further comprises:
time domain configuration information of an SSB burst set, wherein
the time domain configuration information of the SSB burst set comprises at least one of the following:
a periodicity of the SSB burst set; or
position information of at least one sent SSB in the SSB burst set.

16. A terminal, comprising: a processor; and a memory having a computer program or an instruction stored thereon, wherein the computer program or the instruction, when executed by the processor, causes the processor to perform operations comprising:
obtaining time reference information of a first signal; and
determining Synchronization Signal Block (SSB) time information based on the time reference information.

17. The terminal according to claim 16, wherein the SSB time information comprises time information of an SSB burst set.

18. The terminal according to claim 16, wherein the first signal comprises at least one of the following:
a low-power beacon signal;
a keep-alive signal; or
a low-power wake-up signal.

19. The terminal according to claim 16, wherein the time reference information comprises at least one of the following:
first time offset information of the first signal relative to an SSB; or
second time offset information of the first signal relative to a system frame.

20. A non-transitory computer readable storage medium storing instructions that, when executed by a processor, causes the processor to perform operations comprising:
obtaining time reference information of a first signal; and
determining Synchronization Signal Block (SSB) time information based on the time reference information.
